(19) United States
(12) Patent Application Publication
(10) Pub. No.: US 2004/0103370 A1
(43) Pub. Date: May 27, 2004

(54) System and method for rendering MFS XML documents for display

(75) Inventors: Chenhuei J. Chiang, San Jose, CA (US); Shyh-Mei F. Ho, Cupertino, CA (US); Jenny Chengyin Hung, Fremont, CA (US); Benjamin Johnson Sheats, San Jose, CA (US)

Correspondence Address: John L. Rogitz, Rogitz & Associates, 750 B Street, Suite 3120, San Diego, CA, 92101, US

(73) Assignee: International Business Machines Corporation, Armonk, NY

(21) Appl. No.: 10/244,711

(22) Filed: Nov. 27, 2002

(51) Int. Cl. G06F 17/21

(52) U.S. Cl. 715/513

(57) ABSTRACT

A system and method for rendering XML documents for IMS applications includes receiving an IMS message byte stream and translating the byte stream to an XML document. The XML document is then rendered according to a predetermined styling sheet and displayed at a client computer. The predetermined styling sheet can render the XML document so that when displayed it will simulate the display, e.g., of an IBM 3270 terminal typically used to access an IMS application.

### FIELD OF THE INVENTION

The present invention relates generally to computer software, and more specifically to XML rendering software.

### BACKGROUND OF THE INVENTION

By some estimates, nearly seventy percent (70%) of corporate data in the United States and abroad resides on mainframe computers, e.g., S/390 mainframes manufactured by International Business Machines. Moreover, business-to-business (B2B) e-commerce is expected to grow at least five times faster than the rate of business-to-consumer (B2C) e-commerce. Many transactions involving this corporate data can be initiated by Windows/NT servers, UNIX servers, and other servers but the transactions must be completed on the mainframe using existing legacy applications residing thereon.

One very crucial group of legacy applications are the message format service-based information management system applications (“MFS-based IMS applications”) on which many businesses depend heavily. MFS is a facility of the IMS transaction management environment that formats messages to and from many different types of terminal devices. As businesses upgrade their technologies to exploit new B2B technologies, there is a requirement for an easy and effective method for upgrading existing MFS applications to include e-business capabilities. One such e-business capability is the ability to send and receive MFS-based IMS transaction messages as extensible markup language (XML) documents.

The MFS language utility compiles MFS source, generates MFS control blocks in a proprietary format, known as Message Input/Output Descriptors (MID/MOD), and places them in an IMS format library. MFS supports several terminal types, e.g., IBM 3270 terminals, and it was designed so that the IMS application programs using MFS do not have to deal with any device-specific characteristics in the input or output messages. Because MFS provides headers, page numbers, operator instructions, and other literals to the device, the application's input and output messages can be built without having to pass these format literals. MFS identifies all fields in the message response and formats these fields according to the specific device type. This allows application programmers to concentrate their efforts on the business logic of the programs.

Because the IMS application program input/output data structures do not fully describe the end client interaction with these existing MFS applications, there exists a need for a means to deal with information that is buried within various MFS statements. Examples of this information includes 3270 screen attribute bytes and preset function key (PFKey) input data. Many MFS-based IMS application programs are passed PFKey data in input messages, but application logic is not required to recognize that a certain PFKey was pressed and a literal corresponding to that PFKey must be inserted into the input message. This is due to the fact that, at runtime, it is the MFS online processing and not the application that places the literal that corresponds to the PFKey pressed into the appropriate field in the input message.

XML has become the preferred data format to support Web services, B2C and B2B interchanges. However, presently, there does not exist any way by which hypertext transfer protocol (HTTP) requests can be presented to an IMS application and HTTP responses returned.

Accordingly, there is a need for a system and method which will facilitate the accessibility of MFS-based IMS applications with requests that are formatted using XML. In a business-to-consumer environment, the XML transactions are input via an Internet browser. On the other hand, in a business-to-business environment there is no need for a browser. Moreover, there does not exist any way by which MFS XML documents can be rendered, e.g., at a client computer such that the rendition simulates a terminal such as the IBM 3270 terminal or the look of a modern web page.

### SUMMARY OF THE INVENTION

An XML styling sheet includes logic means for rendering an XML document according to a predefined styling sheet. Preferably, the styling sheet includes logic means for displaying the rendered XML document at a client device. In a preferred embodiment, the styling sheet renders the XML document so that it simulates the display of an IBM 3270 terminal. Moreover, the client device is one of the following: a desk-top computer, a lap-top computer, a portable data assistant, and a wireless telephone. The styling sheet can reside in a server that is distanced from the client device or it can reside in a mainframe that is distanced from the client device.

In another aspect of the preferred embodiment of the present invention, a method for displaying XML documents at a client device includes receiving an MFS-based IMS message that is translated to an XML document. The XML document is rendered according to a predetermined styling sheet.

In yet another aspect of the preferred embodiment of the present invention, a method for displaying an XML document includes receiving an IMS message byte stream. The IMS message byte stream is translated to an XML document. Then, the XML document is rendered according to a predefined styling sheet.

In still another aspect of the preferred embodiment of the present invention, a method for displaying an XML document includes translating an IMS message byte stream to an XML document. The XML document is rendered according to a predefined styling sheet.

The preferred embodiment of the present invention will now be described, by way of example, with reference to the accompanying drawings, in which:

### BRIEF DESCRIPTION OF THE DRAWINGS

FIG. 1 is a flow chart of the overall logic of the present invention;

FIG. 2 is a flow chart of the general translation logic of the present invention;

FIGS. 3A and 3B are flow charts of the XML/MFS translation logic of the present invention;

FIG. 4 is a flow chart of the rendering logic;

FIG. 5 is a front plan view of a computer;

FIG. 6 is a front plan view of a computer;

FIG. 7 is a front plan view of a telephone;

FIG. 8 is a front plan view of a portable data assistant (PDA);

FIG. 9 is a block diagram of first system architecture;

FIG. 10A and 10B are block diagrams of a second system architecture;

FIG. 11 is a block diagram of a third system architecture;

FIG. 12 is a block diagram of a fourth system architecture; and

FIG. 13 is a block diagram of a fifth system architecture.

### DESCRIPTION OF AN EMBODIMENT OF THE INVENTION

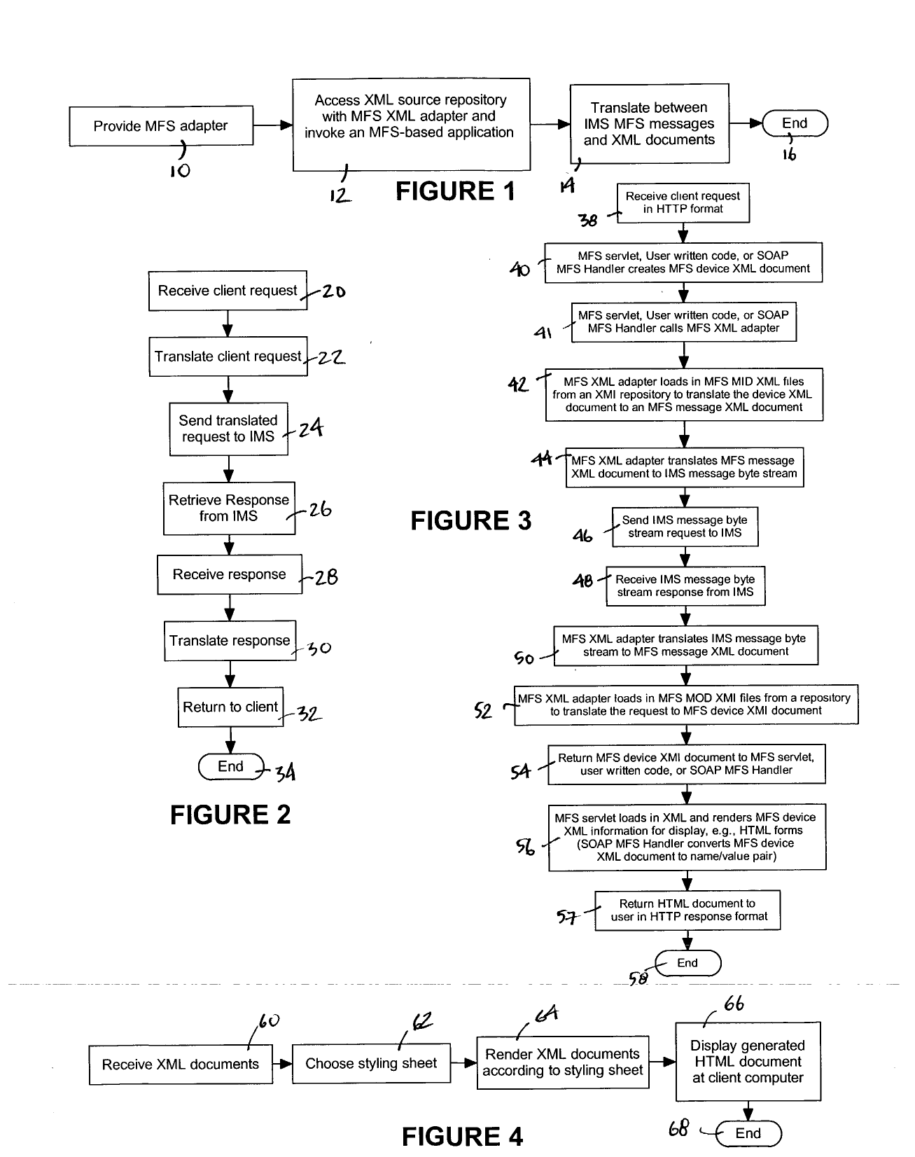

Referring initially to FIG. 1, the overall operating logic of the present invention is shown and commences at block 10 wherein an MFS XML adapter is provided. As described below, the MFS XML adapter includes a mapper which maps the XML document pertaining to the device information into the appropriate MFS XML messages (and vice versa). Also, the MFS XML adapter includes a converter that transforms the MFS XML messages into a byte stream and vice versa. The MFS mapper reads and parses MFS source files for a particular application and generates XMI files that describe the MFS-based application interface using the MFS Metamodel discussed in U.S. patent application ser. No. 09/849,105 filed May 4, 2001, incorporated herein by reference, which is part of the Common Application Metamodel (CAM) disclosed in U.S. patent application ser. No. 60/223,671 filed on Aug. 8, 2000, also incorporated herein by reference.

It is to be understood that there are three external reference pointers to a particular MFS source file: message input descriptor (MID), message output director (MOD), and table. The MFS mapper generates three XMI files for the three external reference pointers. These three files include a “midname.xmi” file for each MID with its associated device input format (DIF), a “modname.xmi” file for each MOD with its associated device output format (DOF), and a “tablename.xmi” file. These XMI files represent all the application interface information encapsulated by the MFS source including the input and output messages, display information, MFS flow control, device characteristics and operation semantics. With these XMI files and the MFS converter, MFS-based IMS applications can support B2B XML communication without altering the MFS-based IMS application.

Returning to FIG. 1, at block 12, the MFS XML adapter has access to an XML source repository and can properly invoke an MFS-based IMS application. It can be appreciated that the MFS-based IMS application contains corporate data, e.g., airline reservation data, rental car availability data, credit data, inventory data, news data, weather data, scheduling data, etc. Continuing to block 14, the MFS XML adapter is used to translate between IMS MFS messages and XML documents. The logic then ends at state 16. As described in greater detail below, the above logic allows a client program to access an MFS-based IMS application via the Internet.

FIG. 2 shows the general translation logic utilized by the MFS XML adapter. Beginning at block 20, a client request (or, a user request), e.g., an HTTP XML document or a SOAP XML document, is received at the MFS XML adapter. At block 22, the MFS XML adapter translates the client request to an IMS MFS message, the XML/MFS translation logic is described in greater detail below. Moving to block 24, the translated request is sent to the MFS-based IMS application. Next, at block 26, a response to the translated request is retrieved from the MFS-based IMS application. Continuing to block 28, the response is received at the MFS XML adapter. The response is translated, at block 30, from an IMS MFS message to the format of the client request, e.g., HTTP XML, SOAP XML, etc. Proceeding to block 32, the translated response is returned to the client program. The logic then ends at state 34.

Referring now to FIGS. 3A and 3B, the XML/MFS translation logic is shown and commences at block 38, wherein a client request is received at an MFS servlet in HTTP request format. Next, at block 40, the MFS servlet creates, user written code, or a SOAP MFS Handler creates an MFS device XML document. At block 41, the MFS servlet, user written code, or SOAP MFS Handler calls the MFS XML adapter and sends the MFS device XML document to the MFS XML adapter. Proceeding to block 42, the MFS XML adapter loads in MFS MID XML files from an XMI repository to translate the device XML document to an MFS message XML document. Moving to block 44, the MFS XML adapter translates the MFS message XML document to an IMS message byte stream. Next, at block 46, the IMS message byte stream request is sent to the MFS-based IMS application. Continuing to block 48, an IMS message byte stream response is received by an MFS XML adapter. At block 50, the MFS adapter translates the IMS message byte stream to an MFS message XML document. Then, at block 52, the MFS XML adapter loads in MFS MOD XMI files from an XMI repository to translate the request to an MFS device XMI. Moving to block 54, the populated MFS XMI document is returned to the MFS servlet, user written code, or SOAP MFS Handler. At block 56, the MFS servlet loads in XML and renders MFS device XML information for display, e.g., HTML forms. In a situation that uses a SOAP MFS handler, the SOAP MFS Handler converts the MFS device XML document to a name/value pair. Then, at block 57, the generated HTML document is returned in HTTP response format or the name/value pair, encapsulated as payload in a SOAP message, is returned to the client, e.g., to the client's web browser. The logic then ends at state 58.

FIG. 4 shows the rendering logic of the present invention. Starting at block 60, XML documents, e.g., XMI source files are received at the MFS XML adapter. Next, at block 62, a styling sheet is chosen. It is to be understood that the styling sheet can emulate the appearance of the display at a terminal such as an IBM 3270. Moreover, the styling sheet can emulate the appearance of nearly any other device, e.g., a wireless telephone, a portable data assistant (PDA), etc. Returning to the rendering logic, at block 64, the XML documents are rendering according to the styling sheet. Moving to block 66, the generated HTML documents are displayed at a web browser of a client device, e.g., a desk-top computer, a lap-top computer, a wireless phone, a PDA, a pager, etc.

It is to be understood that the style sheet provides the necessary information to transform an MFS XMI document into an HTML page. The styling sheet provides information regarding how to render the data on a displayable device. For example, MFS elements are mapped into HTML tags and data. Moreover, in a preferred embodiment, the style sheet contains the following sections: variable declaration, MFS XMI template, MFSDevice Template, MFSCursor Template, MFSDevicesPages Template, MFSAttributes Template, and MFSExtendedAttributes Template. Also, the generated HTML document has the following format:

<html>

<head>

CSS Declaration
JavaScript

<head>
<body>

Forms containing display data, inputs, and buttons

<body>

<html>

Preferably, the variable declaration can include the default values shown in Table 1 in order to best simulate an IBM 3270 terminal.

TABLE 1
Exemplary variable declaration default values
for simulating an IBM 3270 terminal.

| Style sheet variables | Default value |
|---|---|
| servletURL | |
| logicalPage | 1 |
| physicalPage | 1 |
| blue | blue |
| red | red |
| green | lime |
| pink | fuchsia |
| turquoise | aqua |
| yellow | yellow |
| default | aqua |
| neutral | white |
| input | rgb(60, 60, 60) |
| black | black |
| font-family | Courier New |
| font-size | 12 pt |
| font-weight | bold |
| row-multiplier | 21 |
| column-multiplier | 10 |
| border | .5 in |
| cursorRow | 0 |
| cursorColumn | 0 |

The Cascading Style Sheet (CSS) declaration of the above, exemplary HTML document above preferably defines elements which the HTML document can refer to for input styles. The CSS style type is “text/css” and media is “screen”. Table 2, below, lists the defined CSS elements and their properties.

TABLE 2
Exemplary CSS elements and their properties.

| CSS Elements | color | border | background | font-family | font-size | font-weight |
|---|---|---|---|---|---|---|
| Body, table, | default | | background | font-family | font-size | font-weight |
| input | | | | | | |
| redInput | red | border | input | font-family | font-size | font-weight |
| blueInput | blue | border | input | font-family | font-size | font-weight |
| greenInput | green | border | input | font-family | font-size | font-weight |
| pinkInput | pink | border | input | font-family | font-size | font-weight |
| turquoiseInput | turquoise | border | input | font-family | font-size | font-weight |
| yellowInput | yellow | border | input | font-family | font-size | font-weight |
| defaultInput | default | border | input | font-family | font-size | font-weight |
| neutralInput | neutral | border | input | font-family | font-size | font-weight |
| redRevInput | input | border | red | font-family | font-size | font-weight |
| blueRevInput | input | border | blue | font-family | font-size | font-weight |
| greenRevInput | input | border | green | font-family | font-size | font-weight |
| pinkRevInput | input | border | pink | font-family | font-size | font-weight |
| turquoiseRevInput | input | border | turquoise | font-family | font-size | font-weight |
| yellowRevInput | input | border | yellow | font-family | font-size | font-weight |
| defaultRevInput | input | border | default | font-family | font-size | font-weight |
| neutralRevInput | input | border | neutral | font-family | font-size | font-weight |
| blackInput | background | border | input | font-family | font-size | font-weight |
| buttonStyle | neutral | | | font-family | font-size | font-weight |

Also, the JavaScript section of the exemplary HTML document, shown above, preferably provides JavaScript code that are invoked when a client clicks a button. Table 3, below, lists exemplary JavaScript functions and their corresponding descriptions.

TABLE 3
Exemplary JavaScript functions and
their corresponding descriptions.

| JavaScript Functions | Description |
|---|---|
| setFocus(field) | Set the focus on the specified field. |
| clearForm( ) | Clear out all the input fields. |
| resetForm( ) | Reset the values of the input fields. |
| processSubmit(frm) | Fill and submit the form with data from |
| | the input fields. |
| findForms(fSubmit, | Helper function to find a specific form |
| | and copy values from matching |

In a preferred embodiment, the styling sheet adds a submit button at the bottom of the displayed page. Preferably, the submit button functions like the enter key on an IBM 3270 terminal. Moreover, in a preferred embodiment, the styling sheet supports a PA1 button found on a 3270 terminal by providing next and previous buttons to allow the client to move through backward and forward through pages one page at a time. It is to be understood that once the client gets to the last page, toggling the next button will display the same page. Moreover, toggling the previous button at the first page does nothing except continue to display the first page.

Preferably, the styling sheet supports 3270 terminal PF keys. The PF keys can be displayed as buttons on the HTML page. Further, in a preferred embodiment, the styling sheet supports the cursor, which upon loading the document sets the focus on an input field matching the row and column cursor position. Or, the cursor can be placed in the first input field if the cursor position is unspecified or unmatched. Preferably, the styling sheet provides a reset button to restore all fields to their original values that were last received from the IMS application. Also, the styling sheet can provide a clear button to clear all input fields. The clear button cannot unformat the screen, nor will it clear the entire screen like a 3270 terminal Clear key.

It is to be understood that with dynamic attribute modification, certain field attributes can be modified. Examples of modifiable field attributes include: “Protected”, “High-intensity”, “Non-displayable”, and “Set modified data tags”. It is to be understood that data cannot be entered into a “Protected” field and setting the “Protected” attribute to “true” makes the protected text into label text. Preferably, data displayed in a “High-intensity” field is be bolded. Moreover, data entered in a “Non-IBM displayable” field is non-displayable. In the case of “Non-displayable” text label text, the foreground color is set equal to the background color. Moreover, in the case of “Non-displayable” input text, the input type is set to hidden. Further, the “Set modified data tags” attribute allows data sent in this field to be read in on the next input.

In a preferred embodiment, specifying “Protected” and/or “Intensity” attributes results in different default colors. For example, if the “Protected” attribute is equal to “true” and the “Intensity” attribute is equal to “High”, the color can be neutral, e.g., white. If the “Protected” attribute is equal to “true” and the “Intensity” attribute is not specified or not equal to “high”, the color can be turquoise. Also, in a preferred embodiment, if the “Protected” attribute is not specified or not equal to “true” and the “Intensity” attribute is equal to “high”, then the color can be red. And, if the “Protected” attribute is not specified or not equal to “true” and the “Intensity” attribute is not specified or not equal to “true”, the color can be green.

It is to be understood that in a preferred embodiment, the dynamic attribute modification supports a “highlighting”, a “color” attribute, and an “outlining”. Preferably, the “highlighting” attribute includes four settings: “default”, “blink”, “reverse video”, and “underline”. In a non-limiting exemplary embodiment, the “default” setting causes a field to be formatted with a predetermined default font and color assignment. The “blink” setting causes a field to blink. Moreover, the “reverse video” setting causes the foreground and background color of a field to be reversed. Also, the “underline” setting causes a field to be underlined.

Preferably, the “color” attribute includes multiple color settings. For example, the “color” attribute can include the following settings: blue, red, green, turquoise, yellow, pink, default, and neutral. It is to be understood that any other color setting, such as red green blue (RGB) specification, can be used defined in HTML level supported by a browser.

It is to be further understood that the “outlining” attribute preferably is used to set a border around a field and includes five preferred settings: “box”, “over”, “under”, “left”, and “right”. Preferably, the “box” setting places a border over, under, to the left, and to the right of a field. The “over” setting places a border over a field. The “under” setting places a border under a field. The “left” setting places a border to the left of a field. And, the “right” setting places a border to the right of a field.

Table 4, below, provides a list of exemplary, non-limiting templates for mapping MFS elements into HTML tags and data.

TABLE 4
Style Sheet Templates

| | | |
|---|---|---|
| | Condition | |
| MFS Element | and | Generated HTML |
| Template | Explanation | Tags |

| | |
|---|---|
| MFS xmi | <html> |

<head>

CSS declaration
JavaScript declaration

</head>
<body>

MFSDevice template is applied.

</body>

| | | </html> |
|---|---|---|
| MFSDevice | Function key buttons are generated | MFSCursor template is first applied. |
| | for each functionKeyList/functionKeys. | MFSDeviceField template is applied |
| | Index is the nth occurrence of the | for each of the MFSDeviceFields in |
| | function key as specified in the | the same logical and physical page. |
| | xmi:id. | <table style=position: absolute; top: |
| | The table of command buttons are | 535 px; left: 20 px> |

| | |
|---|---|
| generated for submit, reset, clear, | <form> |

| | |
|---|---|
| previous, and next buttons. | <tr> |

| | |
|---|---|
| ServletURL is the destination URL | <td> |

| | |
|---|---|
| of the HTML form. | <input type=submit |

value=PFIndex class=buttonStyle
name=PF_MFSHTMLIndex/>

</td>
...

</td>

</form>

</table>
<table style=position: absolute; top:
590 px; left: 20 px>

<form Name=Info

ONSUBMIT=processSubmit(this)
Action=servletURL method=get>

<tr>

<td>

<input type=“submit”

class=“buttonStyle” value=“Submit”/>

</td>
<td>

<input type=“reset”

value=“Reset” class=“buttonStyle”
onClick=“resetForm( )”/>

</td>
<td>

<input type=“button”

value=“Clear” class=“buttonStyle”
onClick=“clearForm( )”/>

</td>
<td>

<input type=“submit”

name=“previous_page” value=“Previous”
class=“buttonStyle”/>

</td>
<td>

<input type=“submit”

name=“next_page” value=“Next”
class=“buttonStyle”/>

</td>

</tr>
MFSDeviceField template is

| | | applied for each of the MFSDeviceFields |
|---|---|---|
| | | in the same logical and physical page |
| MFSCursor | r = value of the row attribute | Onload = setFocus |
| | c = value of the column attribute | (‘label’) |
| | label = value of label attribute | |
| | of a devicePage, in the same logical | |
| | and physical page, with its position | |
| | matches the specified row (r) and | |
| | column (c) value | |
| MFSDeviceField | option = parameter, default value | |
| | is ‘all’ | |
| | label = value of label attribute | |
| | colorTemplate = the color assigned | |
| | based on MFSAttributes and | |
| | MFSExtendedAttributes templates. | |
| | If value of password attribute is true, | |
| | no op | |
| | ElseIf option = ‘hidden’ and the | <input name=‘label’ type=hidden> |
| | value of attributes/protected does not | |
| | equal ‘true’, input tag is generated | |
| | Else table tag is generated (style | <table style=position: absolute; top: |
| | is generated if position is specified, | ‘rowIndex’; left: ‘columnIndex’; color: |
| | rowIndex = position/row * row-multiplier; | colorTemplate> |

| | |
|---|---|
| columnIndex = position/column * column- | <tr><td> |

| | |
|---|---|
| multiplier) | [<form Name=Info |

| | |
|---|---|
| (color is generated if the value of | ONSUBMIT=return false> |

| | |
|---|---|
| attributes/protected is true.) | <input name=label |

| | |
|---|---|
| (form is generated if the value of | [type=hidden] or [type=text value=value |
| attributes/protected is not true. If the | class=colorTemplate size=length |
| value of attributes/intensity is | maxlength=length]] or |

| | |
|---|---|
| ‘nondisplayable’, then type=hidden, | [<font |

| | else type=text. value is the value | color=colorTemplate>dataValue</font>] |
|---|---|---|
| | of the value attribute. length is the | |
| | value of the length attribute.) | </tr></td> |
| | (font is generated otherwise, dataValue | </table> |
| | is the value of the value attribute, | |
| | with each space character converted to | |
| | a HTML displayable space character: &#160) | |
| MFSAttributes | If the value of protected attribute | [background/green/red/turquoise/neutral] |
| | is true, then background is used if | or |
| | the value of intensity attribute is | [BlackInput/GreenInput/RedInput/Turquoi |
| | nondisplayable; else green, red, | seInput/NeutralInput] |
| | turquoise, or neutral is used if the | |
| | value of ../extendedAttributes/color | |
| | is not specified. (If not(intensity= | |
| | ‘high’) and not(protected= | |
| | ‘true’), return green) | |
| | (If intensity=‘high’ and not | |
| | (protected=‘true’), return Red) | |
| | (If not(intensity=‘high’) and | |
| | protected=‘true’, return Turquoise) | |
| | (If intensity=‘high’ and protected= | |
| | ‘true’, return Neutral). | |
| | Else if the value of protected attribute | |
| | is false or not specified, then BlackInput | |
| | is used if the value of intensity attribute | |
| | is nondisplayable; else GreenInput, | |
| | RedInput, TurquoiseInput, or NeutralInput is | |
| | used if the value of /extendedAttributes/color | |
| | is not specified. (If not(intensity= | |
| | ‘high’) and not(protected=‘true’), | |
| | return GreenInput) | |
| | (If intensity=‘high’ and not | |
| | (protected=‘true’), return RedInput) | |
| | (If not(intensity=‘high’) and | |
| | protected=‘true’, return | |
| | TurquoiseInput) | |
| | If intensity=‘high’ and protected= | |
| | ‘true’, return NeutralInput) | |
| MFSExtendedAttributes | tag = parameter, default value is | [background; background-color: ] or |
| | ‘style’ | |
| | highlighting = value of the | [black] or |
| | highlighting attribute | [blue/red/green/pink/turquoise/yellow/defa |
| | colorTemplate = the color assigned based | ult/neutral] or [BlueRevInput / |
| | on MFSAttributes and MFSExtendedAttributes | RedRevInput /GreenRevInput |
| | templates. | /PinkRevInput /TurquoiseRevInput |
| | If the value of ../attributes/intensity is | /YellowRevInput /DefaultRevInput / |
| | ‘nondisplayable’, then choose among | NeutralRevInput] or [BlueInput /RedInput |
| | the following: | /GreenInput /PinkInput /TurquoiseInput |
| | If highlighting = ‘reverse’ and tag= | /YellowInput /DefaultInput /NeutralInput] |
| | ‘style’, return background color | or [‘; text-decoration:underline’/‘; text- |
| | specification. | |
| | If highlighting = ‘reverse’ and tag= | decoration:blink’/‘; border-color: |
| | ‘font’, return ‘black’. | colorTemplate;border-style: sold; border- |
| | If highlighting=‘reverse’ and tag= | right-width: 0/medium; border-left-width: |
| | ‘font’, then return blue, red, green, | 0/medium; border-top-width: 0/medium; |
| | pink, turquoise, yellow, default, or Neutral | border-button-width: 0/medium] |
| | based on the value of the color attribute. | |
| | Otherwise (the value of ../attributes/intensity | |
| | is not ‘nondisplayable’) choose among the | |
| | following: | |
| | If highlighting = ‘reverse’, then | |
| | return BlueRevInput, RedRevInput, | |
| | GreenRevInput, PinkRevInput, | |
| | TurquoiseRevInput, YellowRevInput, | |
| | DefaultRevInput, or NeutralRevInput | |
| | based on the value of the color attribute. | |
| | Else (highlighting <> ‘reverse’), return | |
| | BlueInput, RedInput, GreenInput, PinkInput, | |
| | TurquoiseInput, YellowInput, DefaultInput, or | |
| | NeutralInput based on the value of the color | |
| | attribute. | |
| | If tag=‘style’ and the value of | |
| | ../attributes/protected is ‘true’, | |
| | then choose from the following: | |
| | If highlighting = ‘underline’, | |
| | then return underline specification. | |
| | If highlighting = ‘blink’, then | |
| | return blink specification. | |
| | If ../outlining is specified, then return | |
| | border specification. | |

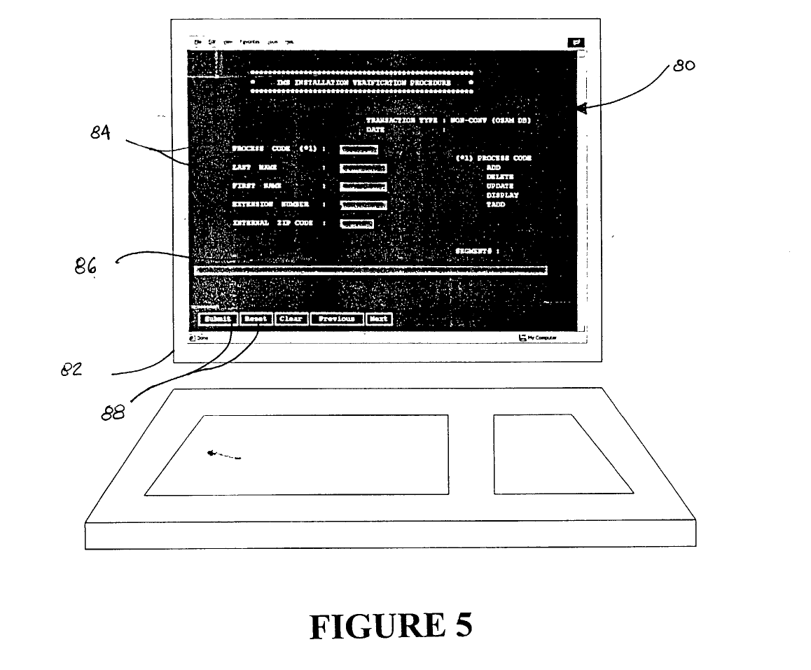

Referring to FIG. 5, one exemplary generic HTML XML rendering for an IMS application, designated 80, is shown at a client device, e.g., a computer 82. FIG. 5 shows that the rendering 80 includes a background 82 that can be monochromatic, e.g., black. Moreover, the rendering 80 includes plural text lines 84. Also, in a preferred embodiment, the rendering 80 includes plural input fields 86. FIG. 5 also shows that the rendering 80 preferably includes plural buttons 88. The non-limiting, exemplary buttons 88 shown in FIG. 5 include: a “Submit” button, a “Reset” button, a “Clear” button, a “Previous” button, and a “Next” button. It is to be understood that the submit button 88 simulates a way for a client to submit the data on 3270 terminal. As shown in FIG. 5, the generic rendering 80 of the XML document returned according to the logic of FIG. 3 can be rendered to simulate the appearance of an IBM 3270 terminal that typically can be used to access an IMS application. Thus, a client who is accustomed to accessing an IMS application via a 3270 terminal and not a web browser will notice very little difference, if any, between the client interface provided by the 3270 terminal and the web browser. Also, the client acclimation time will be minimal. Appendix 1 and appendix 2 show exemplary code that can be used to generate the generic 3270-look rendering shown in FIG. 5. It is to be understood that appendix 1 and appendix 2 are targeted for different HTML and CSS levels. The user must check his or her browser support in choosing the appropriate stylesheet.

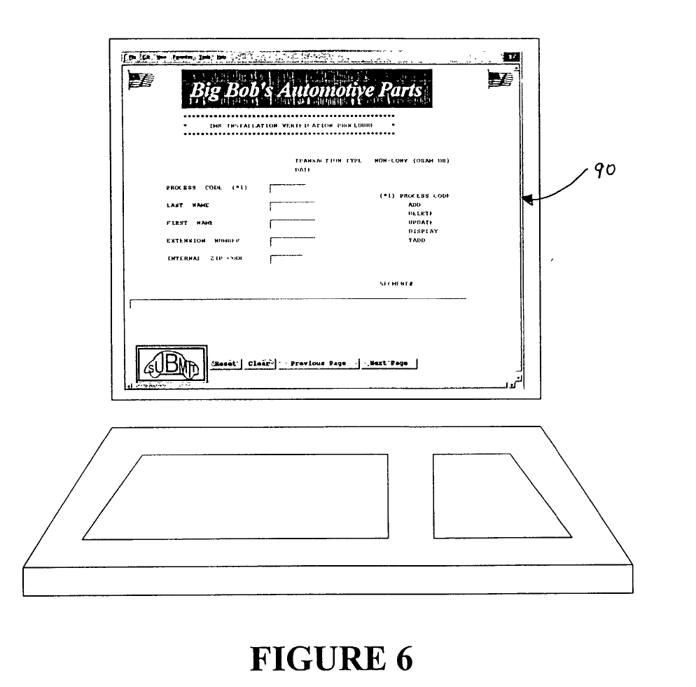

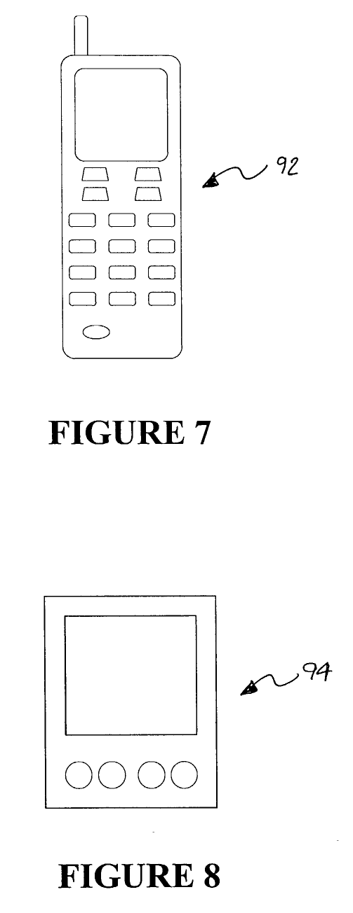

Referring to FIG. 6, an alternative rendering of an HTML XML rendering for an IMS application is shown and designated 90. The alternative rendering 90 shown in FIG. 6 is essentially the same as the generic rendering 80, but is colored and styled to appear like a typical web browser interface. Appendix 3 and appendix 4 show exemplary code that can be used to generate the alternative rendering shown in FIG. 6. It is to be understood that appendix 3 and appendix 4 are targeted for different HTML and CSS levels. FIGS. 7 and 8 show other client devices, e.g., a wireless telephone 92 and a PDA 94. The XML document returned according to the logic shown in FIG. 3 can also be rendered so that it can be displayed on the telephone 92 and/or the PDA 94. Appendix 5 explains certain features that are supported on different HTML levels.

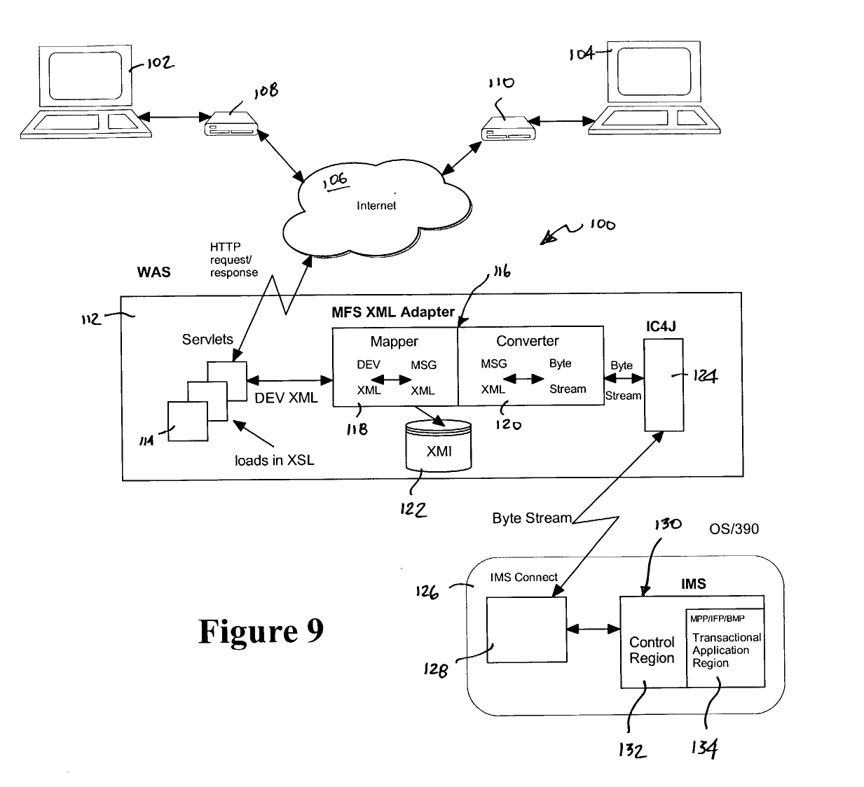

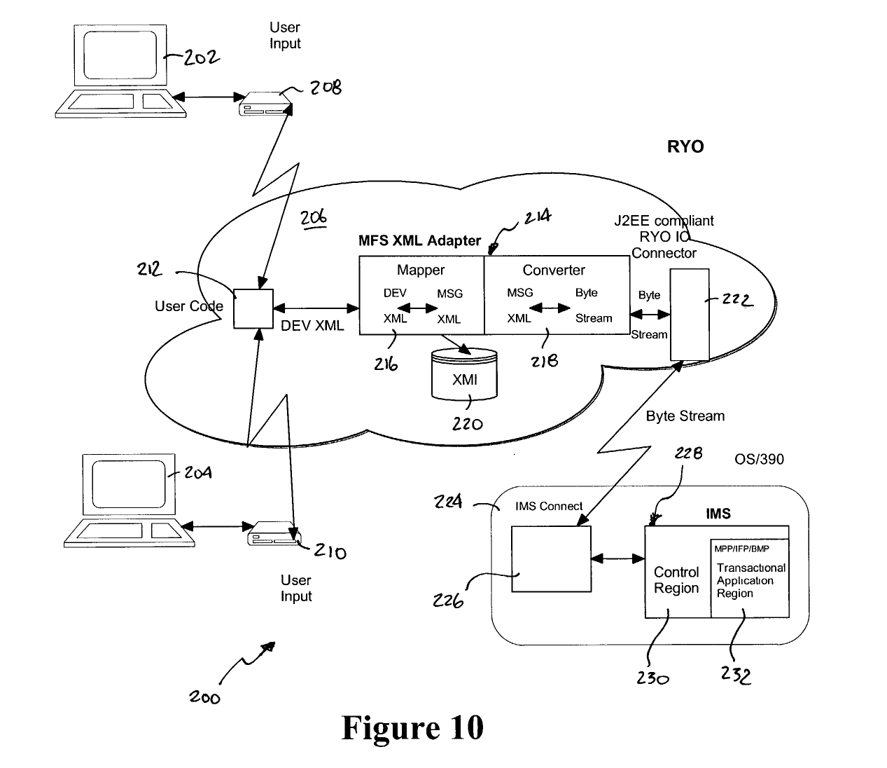

FIGS. 9 through 10 shows various system in which the MFS XML adapter utilizing the above logic can be incorporated. FIG. 9 shows a WebSphere application server (WAS) system that is generally designated 100. Typically, this system 100 is used in for B2C transactions and not B2B transactions. It is to be understood that this system can be any other equivalent web application server system, e.g., TomCat, etc. As shown, the WAS system 100 includes a first client computer 102 and a second client computer 104 that are connected to the Internet 106 by respective modems 108, 110. FIG. 9 shows that the Internet 106 provides a connection to a WebSphere application server (WAS) 112. It is to be understood that client programs that reside in the client computers 102, 104 can communicate with an MFS-based IMS application, described below, via the Internet 106 and the WAS 112.

Within the WAS 112, are plural servlets 114 that load in extensible stylesheet language (XSL) for rendering output displays. The result of the rendering, e.g., an HTML document, is sent back to the client computer 102, 104 in an HTTP response. Each servlet 114 communicates with the MFS XML adapter 116 in which the logic depicted in FIGS. 2 and 3 resides. The servlets 114 send and receive XML documents to and from the MFS XML adapter 116. As shown in FIG. 9, the MFS XML adapter 116 includes an MFS mapper 118 and an MFS converter 120. The MFS mapper 118 is connected to an MFS XMI database 122. The MFS mapper 118 and the MFS converter 120 work together to translate the XML documents into a byte stream that is sent to an IMS connector for Java (IC4J) 124. The IC4J 124 sends the byte stream to a mainframe 126, e.g., an IBM S/390. At the mainframe, the byte stream is received by IMS connect (IC) 128 which, in turn, sends the byte stream to an IMS transaction system 130 within the IMS space of the mainframe 126 via TCP/IP. FIG. 9 shows that in a preferred embodiment the IMS transaction system 130 can include a control region 132 and a transactional application region 134 where IMS applications reside. It is to be understood that, in the above described WAS system 100, the translation between XML and byte stream-occurs within MFS XML adapter 116 which resides inside the WAS 112, or any other web application server.

It is to be understood that each servlet 114 works in conjunction with the MFS XML adapter 116 to transform the HTTP request into a byte stream as input to the IC4J 124 and produce an HTTP response on return. The servlets 114 are responsible for handling display information and producing simulated DIF XMI, and vice versa. The MFS XML adapter 116 is responsible for transforming the XMI into a byte stream and communicating with the IC4J 124—handling both device and message information. Preferably, the MFS XML adapter 116 uses interpretive marshaling based on dynamical lookup of XMI files to ensure system stability.

Further, it is to be understood that all the servlets 114 are subclassed, or inherited, from a generic MFS servlet that contains the bulk of the logic code of the present invention. The generic servlet is responsible for processing the HTTP XML request, invoking the adapter, and loading the stylesheet. Preferably, the generic MFS servlet has the ability to cache the entire message and only return a single page at time to the client computer. Thus, the client is able to page through logical pages and physical pages without making extra requests to the MFS XML adapter 116 (and the IMS transaction system 130). In a preferred embodiment, the generic servlet passes to a predetermined stylesheet only the device page and device fields pertaining to the current physical and logical page. Preferably, an instance servlet is only generated for each initial MOD. Once an HTTP session is established with a particular client, the session can keep track of which page the client is currently viewing. The instance servlet can provide key details regarding the specific transaction. These details can include IMS information (e.g., hostname, port number, and data store name), stylesheet name, and initial MFS modname.

While the servlets 114 handle only the device side of the MFS model, the MFS XML adapter 116 preferably handles both the device side and the message side of the model. As stated above, the MFS XML adapter 116 includes two parts: the MFS mapper 118 and the MFS converter 120. Based on the information contained in the MID/MOD XMI file, the MFS mapper 118 will map the simulated input device information into the appropriate message components (and vice versa). In a preferred, non-limiting embodiment, the simulated input device information is as follows:

<?xml version=“1.0” encoding=“UTF-8”?>
<xmi:XMI xmi:version=“2.0” xmlns:xmi=“http://www.omg.org/XMI” xmlns:mfs
=“mfs.xmi”>

<mfs:MFSFormat xmi:id=“MFSFormat_1”>

<devices xmi:id=“MFSDevice_1”>

<devicePages xmi:id=“MFSDevicePage_1”>

<deviceFields xmi:id=“MFSDeviceField_1” label=“LABEL1” value

=“VALUE1”>

<deviceFields xmi:id=“MFSDeviceField_2” label=“LABEL2” value

=“VALUE2”>

<deviceFields xmi:id=“MFSDeviceField_N” label=“LABELN” value

=“VALUEN”>

</devicePages>
<division xmi:id=“MFSDeviceDivision/” type=“in”>

</devices>

</mfs:MFSFormat></xmi:XMI>

In a preferred embodiment, only the MFS mapper 118 accesses the MFS XMI database 122. Additionally, the MFS mapper 118 preferably handles communication with the IC4J 124. It is to be understood that the MFS XML adapter 116 and the IC4J 124 operate under the J2EE framework. Thus, an IC Client connector substituted for the IC4J 124 has to be J2EE compliant as well, as shown in FIGS. 5 and 7 and described below. Preferably, the MFS mapper 118 handles the situation when the IMS transaction system 130 switches the modname during data transfer by transparently loading the new MFS XMI file and returning the new device XMI to the servlet for display. In a preferred embodiment, if the corresponding MFS XMI file cannot be located for the specific modname, the MFS mapper 118 quits processing and returns a failure message.

It is to be understood that the MFS converter 120 of the MFS XML adapter 116 transforms the XMI message into a byte stream and transforms a byte stream into an XMI message. The MFS converter 120 only deals with the message side of the MFS model. The MFS converter 120, when converting to and from a byte steam, uses predetermined Type Descriptor classes in the XMI file to perform the low level UNICODE to extended binary coded decimal information code (EBCDIC) conversion.

Referring now to FIGS. 10A and 10B, a roll-your-own (RYO), or client customized, IC system is shown and generally designated 200. It is to be understood that this system 200 is typically used for B2B transactions and not B2C transactions. FIGS. 10A and 10B (collectively “FIGURE 10”) show that the RYO IC system 200 includes a first client computer 202 and a second client computer 204 connected to a RYO IC client application program 206 via respective networking devices 208, 210. It is to be understood that at least one client program resides on the client computers 202, 204. Specifically, the computers 202, 204 are connected to user written code 212. The user written code 212 is connected to the MFS XML adapter 214 that includes an MFS mapper 216 and an MFS converter 218. The MFS mapper 216 is connected to an MFS-based extensible markup language meta data interchange (XMI) database 220. The MFS mapper 216 and the MFS converter 218 work together to translate XML documents into a byte stream that is sent to a J2EE compliant RYO IC Connector 222. The J2EE compliant RYO IC Connector 222 sends the byte stream to a mainframe 224, e.g., an IBM S/390. At the mainframe 224, the byte stream is received by IMS connect (IC) 226 which, in turn, sends the byte stream to the IMS transaction system 228 within the mainframe 230. FIG. 10 shows that the IMS transaction system 228 includes a control region 230 and a transactional application region 232. It is to be understood that, in the above described RYO IC system 200, the translation between XML and byte stream occurs within any RYO IC client application program 206 in the network. The RYO IC client can choose to process the resulting XML document by rendering it with the sample styling sheet and sending display data back to the client.

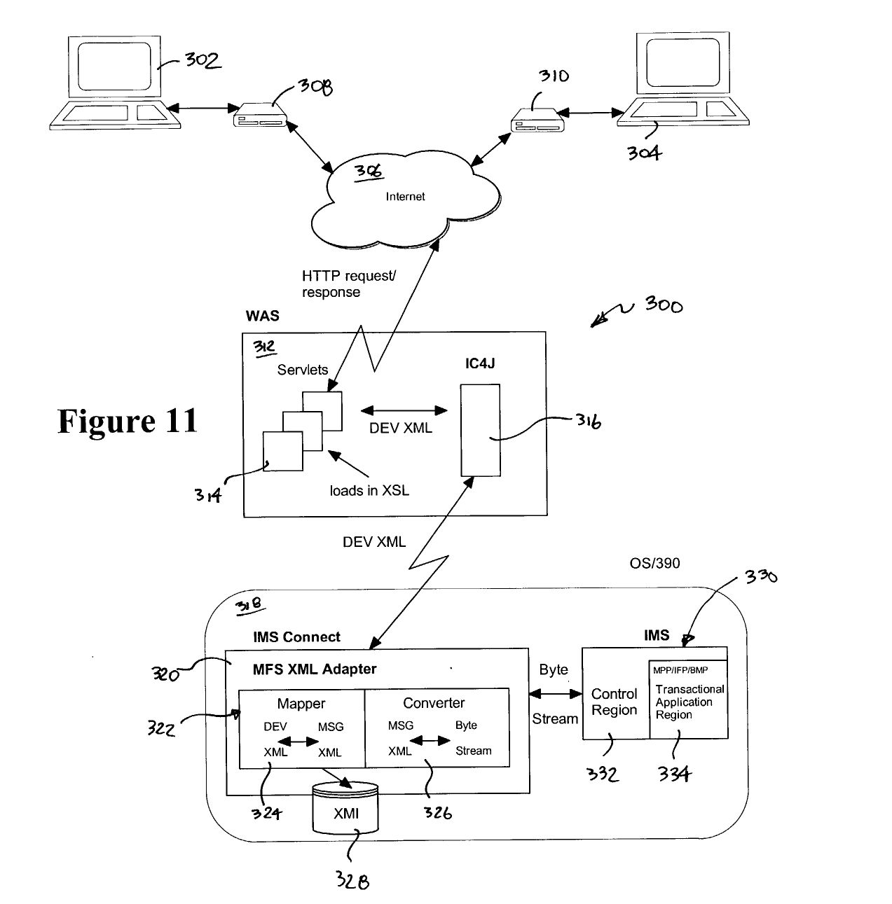

FIG. 1 shows an alternative WebSphere application server (WAS) system that is generally designated 300. As shown, the WAS system 300 includes a first client computer 302 and a second client computer 304 connected to the Internet 306 by respective modems 308, 310. It is to be understood that at least one client program resides on the client computers 302, 304. FIG. 11 shows that the Internet 306 provides a connection to a WebSphere application server (WAS) 312.

Within the WAS 312, are plural servlets 314 that load in extensible stylesheet language (XSL) for rendering output displays. The result of the rendering, e.g., an HTML document, is sent back to the client computer 102, 104 in an HTTP response. The servlets 314 are connected to an IC4J 316 that sends the XML request to the mainframe 318, e.g., the S/390 mainframe. Within the mainframe 318 is IMS connect 320 that includes an MFS XML adapter 322 in which the translation logic depicted in FIGS. 2 and 3 resides. As shown in FIG. 11, the MFS XML adapter 322 includes an MFS mapper 324 and an MFS converter 326. As shown, the MFS mapper 324 is connected to an MFS XMI database 328. The MFS mapper 324 and the MFS converter 326 work together to translate the XML documents into a byte stream that is sent to an IMS transaction system 330 within the mainframe 318. FIG. 11 shows that the IMS transaction system 330 includes a control region 332 and a transactional application region 334. It is to be understood that, in the above described WAS system 300, the translation between XML and byte stream occurs within the IMS connect 320 of the mainframe 318.

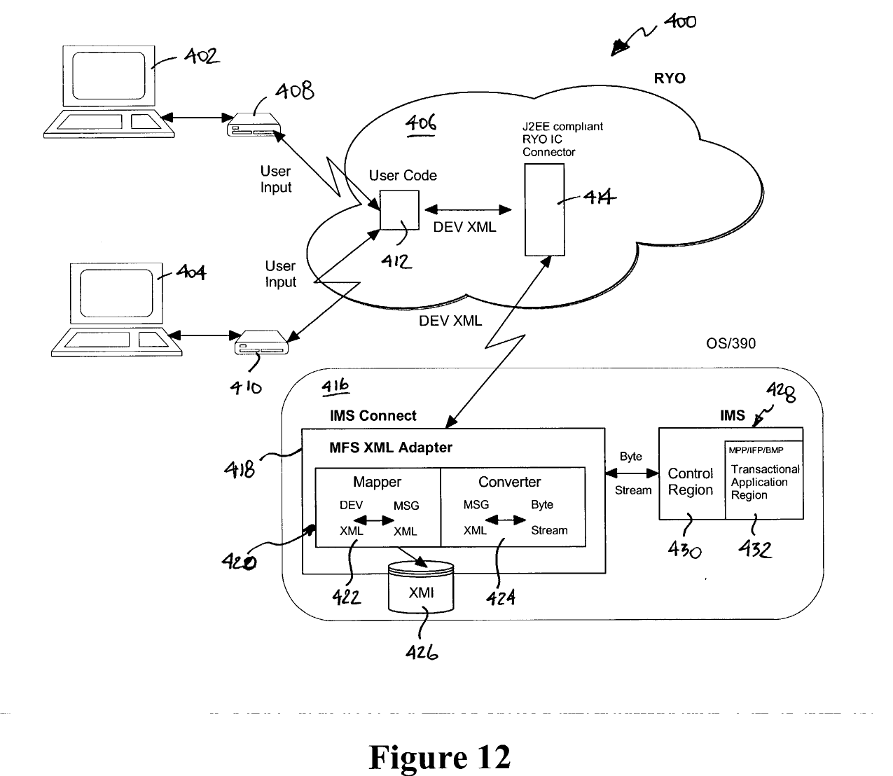

Referring now to FIG. 12, an alternative roll-your-own (RYO) IC system is shown and generally designated 400. It is to be understood that this system is typically used for B2B transactions and not B2C transactions. FIG. 12 shows that the RYO IC system 400 includes a first client computer 402 and a second client computer 404 connected to a RYO IC client application program 406 via respective networking devices 408, 410. Specifically, the computers 402, 404 are connected to a user written code 412. It is to be understood that at least one client program resides on the client computers 402, 404.

As shown in FIG. 12, the user written code 412 is connected to a J2EE compliant RYO IC connector 414, that sends the XML request to a mainframe 416, e.g., the S/390 mainframe. Within the mainframe 416 is IMS connect 418 that includes an MFS XML adapter 420 that utilizes the translation logic depicted in FIGS. 2 and 3. As shown in FIG. 12, the MFS XML adapter 420 includes an MFS mapper 422 and an MFS converter 424. As shown, the MFS mapper 422 is connected to an MFS XMI database 426. The MFS mapper 420 and the MFS converter 424 work together to translate the XML documents into a byte stream that is sent to an IMS transaction system 428 also within the mainframe 416. FIG. 12 shows that the IMS transaction system 428 includes a control region 430 and a transactional application region 432. It is to be understood that, in the above described RYO IC system 400, the translation between XML and byte stream occurs within IMS Connect 418 of the mainframe 416. The RYO IC client can choose to process the resulting XML document by rendering it with the sample styling sheet and sending display data back to the client.

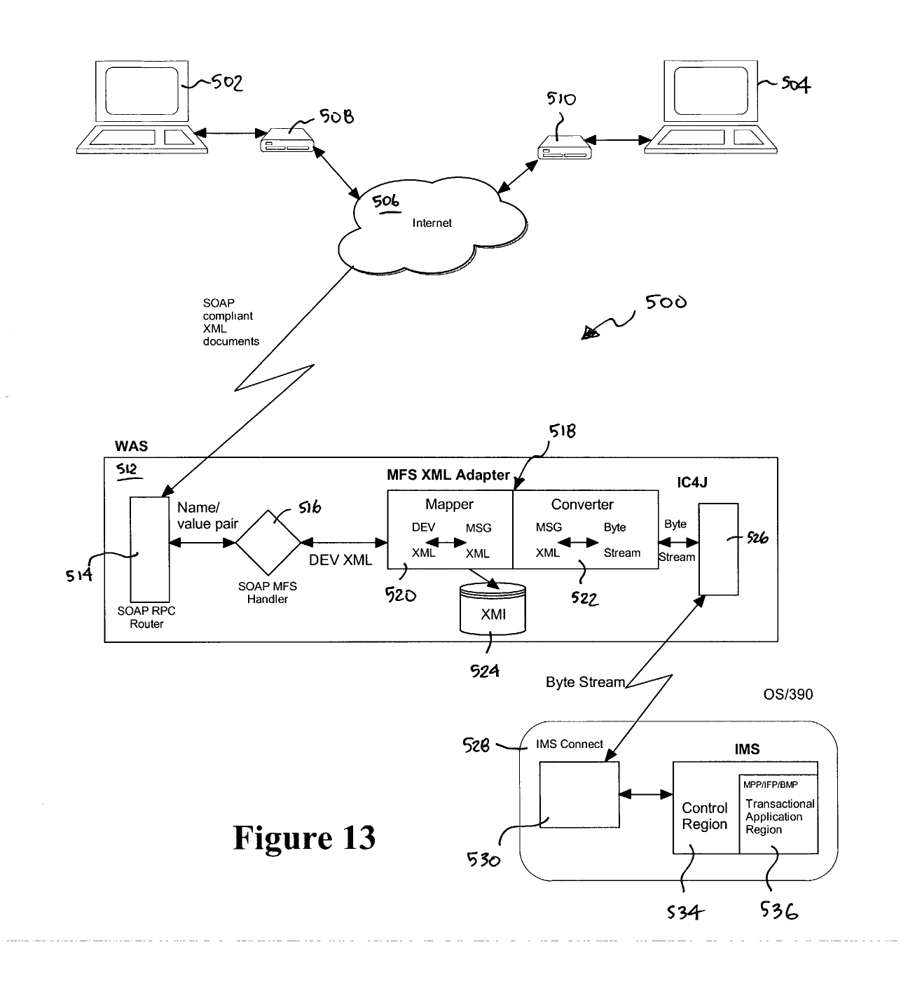

FIG. 13 shows a third WAS system, generally designated 500, in which SOAP compliant XML documents are utilized. As shown, the system 500 includes a first client computer 502 and a second client computer 504 that are connected to the Internet 506 by respective modems 508, 510. FIG. 13 shows that the Internet 506 provides a connection to a WAS 512. It is to be understood that at least one client program resides on the client computers 502, 504.

Within the WAS 512, is a SOAP RPC Router 514 that receives SOAP compliant XML documents. The router 514 constructs a name/value pair from the SOAP compliant XML documents and sends them to a SOAP MFS handler 516. The SOAP MFS handler 516 sends a DEV XML document to an MFS XML adapter 518 in which the logic depicted in FIGS. 2 and 3 resides. As shown in FIG. 13, the MFS XML adapter 518 includes an MFS mapper 520 and an MFS converter 522. The MFS mapper 520 is connected to an MFS XMI database 524. In accordance with t translation logic, the MFS mapper 520 the MFS 522 work together to translate the DEV XML documents into a byte stream that is sent to an IC4J 526. The IC4J 526 sends the byte stream to a mainframe 528, e.g., an IBM S/390. At the mainframe, the byte stream is received by IMS connect (IC) 530 which, in turn, sends the byte stream to an IMS transaction system 532 within the mainframe 528. FIG. 13 shows that the IMS transaction system 532 includes a control region 534 and a transactional application region 536. It is to be understood that, in the above described WAS system 500, the translation between XML and byte stream occurs within the MFS XML adapter 518 that resides in the WAS 512.

It can be appreciated that in each of the exemplary systems 100, 200, 300, 400, 500, described above, the client requests, e.g., HTTP XML documents or a SOAP XML documents, are received at a generic MFS XML adapter 116, 214, 322, 420, 518. The MFS XML adapter 116, 214, 322, 420, 518 converts the client requests into MFS-based IMS message byte streams and sends them to MFS-based IMS applications 130, 228, 330, 428, 532 where they can be processed. The MFS-based IMS applications return responses that are converted by the MFS XML adapter 116, 214, 322, 420, 518 back into HTTP XML documents or SOAP XML documents that can be rendered at one or more clients+ web browsers, as described above. Thus, the MFS XML adapter 116, 214, 322, 420, 518 acts as a two-way translator to facilitate client interaction with MFS-based IMS applications 130, 228, 330, 428, 532 via the Internet 106, 306, 506 or an RYO connection 206, 406. Appendix 6 shows a non-limiting, exemplary MFS XMI, described above.

It is to be understood that in each of the systems above, the translation logic can be contained on a data storage device with a computer readable medium, such as a computer diskette. Or, the instructions may be stored on a magnetic tape, hard disk drive, electronic read-only memory (ROM), optical storage device, or other appropriate data storage device or transmitting device thereby making a computer program product, i.e., an article of manufacture according to the invention. In an illustrative embodiment of the invention, the computer-executable instructions may be lines of C++ compatible code.

The flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its essential embodiment by a machine component that renders the program elements in a form that instructs a digital processing apparatus (that is, a computer) to perform a sequence of function steps corresponding to those shown.

With the configuration of structure described above, it is to be appreciated that system and method described above provides a means for receiving web-based client requests, translating them to MFS IMS, and submitting the translated requests to IMS applications. Thus, corporate data and other data that operates within MFS-based IMS application programs and that is typically accessed via terminals can be accessed via Internet connections. This allows corporations the option of allowing access to their data via the Internet.

While the particular SYSTEM AND METHOD FOR RENDERING MFS XML DOCUMENTS FOR DISPLAY as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiments that known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

[image]

1. An XML styling sheet, comprising:
logic means for receiving an information management service message byte stream via message format service;
logic means for translating the information management service message byte stream to an XML document; and
logic means for rendering the XML document according to a predefined styling sheet.

2. The styling sheet of claim 1, further comprising:
logic means for displaying a rendered XML document at a client device.

3. The styling sheet of claim 2, wherein the client device is at least one of the following:
a desk-top computer, a lap-top computer, a portable data assistant, and a wireless telephone.

4. The styling sheet of claim 2, wherein the styling sheet renders the XML document so that it simulates the display of an IBM 3270 terminal.

5. The styling sheet of claim 2, wherein the styling sheet renders the XML document so that it simulates the display of a web browser interface.

6. The styling sheet of claim 1, when the styling sheet resides in a server that is distanced from the client device.

7. The styling sheet of claim 1, wherein the styling sheet resides in a mainframe that is distanced from the client device.

8. A method for displaying XML documents at a client device comprising the acts of:
receiving an MFS-based IMS message that is translated to an XML document, the XML document being rendered according to a predetermined styling sheet.

9. The method of claim 8, further comprising the act of:
displaying a rendered XML document at a client device.

10. The method of claim 9, wherein the client device is at least one of the following: a desk-top computer, a lap-top computer, a portable data assistant, and a wireless telephone.

11. The method of claim 9, wherein the styling sheet renders the XML document so that it simulates the display of an IBM 3270 terminal.

12. The method of claim 9, wherein the styling sheet renders the XML document so that it simulates the display of a web browser interface.

13. The method of claim 8, wherein the styling sheet resides in a server that is distanced from the client device.

14. The method of claim 8, wherein the styling sheet resides in a mainframe that is distanced from the client device.

15. A method for displaying an XML document, comprising the acts of:
receiving an IMS message byte stream;
translating the IMS message byte stream to an XML document; and
rendering the XML document according to a predefined styling sheet.

16. The method of claim 15, further comprising the act of displaying a rendered XML document at a client device.

17. The method of claim 16, wherein the client device is at least one of the following: a desk-top computer, a lap-top computer, a portable data assistant, and a wireless telephone.

18. The method of claim 16, wherein the styling sheet renders the XML document so that it simulates the display of an IBM 3270 terminal.

19. The method of claim 16, wherein the styling sheet renders the XML document so that it simulates the display of a web browser interface.

20. The method of claim 15, wherein the styling sheet resides in a server that is distanced from the client device.

21. The method of claim 15, wherein the styling sheet resides in a mainframe that is distanced from the client device.

22. A method for displaying an XML document, comprising the acts of:
translating an IMS message byte stream to an XML document; and
rendering the XML document according to a predefined styling sheet.

23. The method of claim 22, further comprising the act of:
sending a rendered XML document to a client device.

24. The method of claim 23, further comprising the act of:
displaying the rendered XML document at the client device.

25. The method of claim 24, wherein the client device is at least one of the following: a desk-top computer, a lap-top computer, a portable data assistant, and a wireless telephone.

26. The method of claim 24, wherein the styling sheet renders the XML document so that it simulates the display of an IBM 3270 terminal.

27. The method of claim 24, wherein the styling sheet renders the XML document so that it simulates the display of a web browser interface.

28. The method of claim 22, wherein the styling sheet resides in a server that is distanced from the client device.

29. The method of claim 22, wherein the styling sheet resides in a mainframe that is distanced from the client device.
